(19) United States
(12) Patent Application Publication
(10) Pub. No.: US 2025/0006991 A1
(43) Pub. Date: Jan. 2, 2025

(54) ELECTROLYTE SOLUTION FOR LITHIUM SECONDARY BATTERY INCLUDING SALT OF METAL ELEMENT AND LITHIUM SECONDARY BATTERY INCLUDING SAME

(71) Applicants: HYUNDAI MOTOR COMPANY, Seoul (KR); KIA CORPORATION, Seoul (KR); Korea Advanced Institute of Science and Technology, Daejeon (KR)

(72) Inventors: Eun Ji Kwon, Yongin-si (KR); Ji Yong Lee, Seongnam-si (KR); Won Keun Kim, Seoul (KR); Samuel Seo, Yongin-si (KR); Yeon Jong Oh, Seoul (KR); Kyu Ju Kwak, Hwaseong-si (KR); Dong Hyun Lee, Seoul (KR); Sang Su Lee, Suwon-si (KR); Kyoung Han Ryu, Yongin-si (KR); Ji Ho Lim, Seoul (KR); Nam Soon Choi, Daejeon (KR); Jeong A Lee, Daejeon (KR); Jeong Hwan Byun, Daejeon (KR)

(73) Assignees: HYUNDAI MOTOR COMPANY, Seoul (KR); KIA CORPORATION, Seoul (KR); Korea Advanced Institute of Science and Technology, Daejeon (KR)

(21) Appl. No.: 18/527,957

(22) Filed: Dec. 4, 2023

(30) Foreign Application Priority Data
Jun. 21, 2023 (KR) 10-2023-0079837

(51) Int. Cl. H01M 10/0567; H01M 4/66; H01M 10/0525; H01M 10/0569; H01M 10/42

(52) U.S. Cl. CPC H01M 10/0567; H01M 4/662; H01M 4/667; H01M 10/0525; H01M 10/0569; H01M 10/4235; H01M 2004/027; H01M 2300/0034

(57) ABSTRACT

An electrolyte solution for a lithium secondary battery includes a salt of metal element as an additive and a lithium secondary battery including the same.

### CROSS-REFERENCE TO RELATED APPLICATION

The present application claims priority to Korean Patent Application No. 10-2023-0079837, filed on Jun. 21, 2023, the entire contents of which is incorporated herein for all purposes by this reference.

### BACKGROUND OF THE PRESENT DISCLOSURE

### Field of the Present Disclosure

The present disclosure relates to an electrolyte solution for a lithium secondary battery including a salt of metal element as an additive and a lithium secondary battery including the same.

### Description of Related Art

An anode-free lithium secondary battery is a next-generation battery that eliminates anode materials such as graphite, which occupy a lot of volume and weight in conventional batteries.

In the anode-free lithium secondary battery, only an anode current collector made of copper is included in the anode, and lithium ions (Lit) in a cathode material pass through a separator via an electrolyte solution and are stored in the form of lithium metal element on the anode current collector.

Although anode-free lithium secondary batteries have energy density increased by at least 60% per volume compared to conventional batteries, commercialization thereof is difficult due to problems such as rapid capacity deterioration and short lifespan. In particular, since electrodeposition of lithium ions is not efficient on the anode current collector made of copper, overvoltage occurs, which may cause side reaction between the anode current collector and the electrolyte solution.

The information disclosed in this Background of the present disclosure section is only for enhancement of understanding of the general background of the present disclosure and may not be taken as an acknowledgement or any form of suggestion that this information forms the related art already known to a person skilled in the art.

### BRIEF SUMMARY

Various aspects of the present disclosure are directed to providing an electrolyte solution for a lithium secondary battery capable of suppressing side reaction between lithium metal element and an electrolyte solution and a lithium secondary battery including the same.

Another object of the present disclosure is to provide an electrolyte solution for a lithium secondary battery capable of improving reversibility of lithium ions and a lithium secondary battery including the same.

The objects of the present disclosure are not limited to the foregoing. The objects of the present disclosure will be able to be clearly understood through the following description and to be realized by the means described in the claims and combinations thereof.

An exemplary embodiment of the present disclosure provides an electrolyte solution for a lithium secondary battery, including a solvent, a lithium salt, and an additive including a metal element, in which the metal element may include at least one selected from the group consisting of silver (Ag), gold (Au), platinum (Pt), and combinations thereof.

The solvent may include dimethylsulfamoyl fluoride.

The lithium salt may include at least one selected from the group consisting of lithium bis(fluorosulfonyl)imide ((SO₂F)₂NLi, LiFSI), lithium bis(trifluoromethanesulfonyl)imide ((CF₃SO₂)₂NLi, LiTFSI), LiCI, LiBr, LiI, LiCIO₄, LiBF₄, LiB₁₀Cl₁₀, LiPF₆, LiCF₃SO₃, LiCF₃CO₂, LiCABO₈, LiAsF₆, LiSbF₆, LiAlCl₄, and combinations thereof.

The additive may include at least one selected from the group consisting of a nitrate of the metal element, a halogen salt of the metal element, and combinations thereof.

The additive may include at least one selected from the group consisting of AgNO₃, AuBr₃, Pt(NO₃)₄, and combinations thereof.

The electrolyte solution may include 0.05 wt % to 0.1 wt % of the additive.

Another exemplary embodiment of the present disclosure provides a lithium secondary battery, including an anode current collector, a separator disposed on the anode current collector, a cathode active material layer disposed on the separator, a cathode current collector disposed on the cathode active material layer, and an electrolyte solution impregnated in at least one of the anode current collector, the separator, the cathode active material layer, and the cathode current collector, wherein the electrolyte solution may include a solvent, a lithium salt, and an additive including a metal element, and a work function of the metal element may be higher than a work function of the anode current collector.

The anode current collector may include a substrate including copper (Cu) and a coating layer applied onto the surface of the substrate and including an alloy of copper (Cu) and the metal element.

The work function of the metal element may be greater than 4.7 eV and smaller than or equal to 6 eV.

The lithium secondary battery may further include a solid electrolyte interphase layer in at least one position between the cathode active material layer and the separator and between the anode current collector and the separator, in which the solid electrolyte interphase layer may not include an organic material.

The solid electrolyte interphase layer may include at least one selected from the group consisting of LiF, Li₂CO₃, LiO, and combinations thereof.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a lithium secondary battery according to an exemplary embodiment of the present disclosure;

FIG. 2 shows a lithium secondary battery according to an exemplary embodiment of the present disclosure that is charged:

FIG. 3 shows a lithium secondary battery according to another exemplary embodiment of the present disclosure:

FIG. 4 shows an anode current collector according to an exemplary embodiment of the present disclosure:

FIG. 5A, FIG. 5B, FIG. 5C, and FIG. 5D show changes with time when storing lithium in 1,2-dimethoxyethane for 1 week, FIG. 5A showing results on day 1, FIG. 5B showing results on day 3, FIG. 5C showing results on day 5, and FIG. 5D showing results on day 7:

FIG. 6A, FIG. 6B, FIG. 6C, and FIG. 6D show changes with time when storing lithium in dimethylsulfamoyl fluoride for 1 week, FIG. 6A showing results on day 1, FIG. 6B showing results on day 3, FIG. 6C showing results on day 5, and FIG. 6D showing results on day 7:

FIG. 7A, FIG. 7B, and FIG. 7C show results of analyzing the surface of lithium metal element by X-ray photoelectron spectroscopy (XPS) after storing lithium metal element in each of 1,2-dimethoxyethane and dimethylsulfamoyl fluoride for 1 week, FIG. 7A showing results for the F Is peak, FIG. 7B showing results for the C Is peak, and FIG. 7C showing results for the O Is peak:

FIG. 8 shows results of X-ray diffraction (XRD) of the anode current collector of each cell in Test Example 2:

FIG. 9A, FIG. 9B, FIG. 9C, and FIG. 9D show results of X-ray photoelectron spectroscopy (XPS) of the anode current collector of each cell in Test Example 2, FIG. 9A showing results for the Ag 3d peak, FIG. 9B showing results for the Ag 3d peak, FIG. 9C showing results for the Au 4f peak, and FIG. 9D showing results for the Pt 4f peak:

FIG. 10A shows initial efficiency of each cell in Test Example 3:

FIG. 10B shows an enlarged view of FIG. 10A.

FIG. 11 shows results of visual observation of electrodeposited lithium of each cell in Test Example 3:

FIG. 12A shows results of analyzing the surface of electrodeposited lithium of a cell in Test Example 3 which does not include an additive with a scanning electron microscope:

FIG. 12B shows results of analyzing the surface of electrodeposited lithium of a cell in Test Example 3 which includes 0.05 wt % of AgNO₃ with a scanning electron microscope:

FIG. 12C shows results of analyzing the surface of electrodeposited lithium of a cell in Test Example 3 which includes 0.1 wt % of AgNO₃ with a scanning electron microscope:

FIG. 12D shows results of analyzing the surface of electrodeposited lithium of a cell in Test Example 3 which includes 0.05 wt % of AuBr₃ with a scanning electron microscope:

FIG. 12E shows results of analyzing the surface of electrodeposited lithium of a cell in Test Example 3 which includes 0.05 wt % of Pt(NO₃) 3 with a scanning electron microscope:

FIG. 12F shows results of analyzing the cross section of electrodeposited lithium of a cell in Test Example 3 which does not include an additive with a scanning electron microscope:

FIG. 12G shows results of analyzing the cross section of electrodeposited lithium of a cell in Test Example 3 which includes 0.05 wt % of AgNO₃ with a scanning electron microscope:

FIG. 12H shows results of analyzing the cross section of electrodeposited lithium of a cell in Test Example 3 which includes 0.1 wt % of AgNO₃ with a scanning electron microscope:

FIG. 12I shows results of analyzing the cross section of electrodeposited lithium of a cell in Test Example 3 which includes 0.05 wt % of AuBr₃ with a scanning electron microscope:

FIG. 12J shows results of analyzing the cross section of electrodeposited lithium of a cell in Test Example 3 which includes 0.05 wt % of Pt(NO₃) 3 with a scanning electron microscope:

FIG. 13 shows results of evaluating the lifespan of each cell in Test Example 4:

FIG. 14A shows a formation charge/discharge of each cell in Test Example 5:

FIG. 14B shows a cycle discharge capacity of each cell in Test Example 5:

FIG. 14C shows a coulombic efficiency of each cell in Test Example 5:

FIG. 15A shows C Is spectrum of X-ray photoelectron spectroscopy (XPS) of the surface of the anode current collector of each cell in Test Example 6:

FIG. 15B shows F Is spectrum of X-ray photoelectron spectroscopy (XPS) of the surface of the anode current collector of each cell in Test Example 6:

FIG. 15C shows O Is spectrum of X-ray photoelectron spectroscopy (XPS) of the surface of the anode current collector of each cell in Test Example 6:

FIG. 15D shows N Is spectrum of X-ray photoelectron spectroscopy (XPS) of the surface of the anode current collector of each cell in Test Example 6;

FIG. 15E shows S 2p spectrum of X-ray photoelectron spectroscopy (XPS) of the surface of the anode current collector of each cell in Test Example 6: FIG. 16A shows Ag 3d spectrum of X-ray photoelectron spectroscopy (XPS) of the surface of the anode current collector of each cell in Test Example 6:

FIG. 16B shows Au 4f spectrum of X-ray photoelectron spectroscopy (XPS) of the surface of the anode current collector of each cell in Test Example 6:

FIG. 16C shows Pt 4f spectrum of X-ray photoelectron spectroscopy (XPS) of the surface of the anode current collector of each cell in Test Example 6: FIG. 17A shows C Is spectrum of X-ray photoelectron spectroscopy (XPS) of the surface of the cathode active material layer of each cell in Test Example 6:

FIG. 17B shows F Is spectrum of X-ray photoelectron spectroscopy (XPS) of the surface of the cathode active material layer of each cell in Test Example 6:

FIG. 17C shows O Is spectrum of X-ray photoelectron spectroscopy (XPS) of the surface of the cathode active material layer of each cell in Test Example 6:

FIG. 17D shows N Is spectrum of X-ray photoelectron spectroscopy (XPS) of the surface of the cathode active material layer of each cell in Test Example 6:

FIG. 17E shows S 2p spectrum of X-ray photoelectron spectroscopy (XPS) of the surface of the cathode active material layer of each cell in Test Example 6:

FIG. 18A shows Ag 3d spectrum of X-ray photoelectron spectroscopy (XPS) of the surface of the cathode active material layer of each cell in Test Example 6:

FIG. 18B shows Au 4f spectrum of X-ray photoelectron spectroscopy (XPS) of the surface of the cathode active material layer of each cell in Test Example 6: and

FIG. 18C shows Pt 4f spectrum of X-ray photoelectron spectroscopy (XPS) of the surface of the cathode active material layer of each cell in Test Example 6.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments. On the contrary, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

of the present disclosure will be more clearly understood from the following exemplary embodiments taken However, the present disclosure is not limited to the embodiments disclosed herein, and may be modified into different forms. These embodiments are provided to thoroughly explain the present disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in the present specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

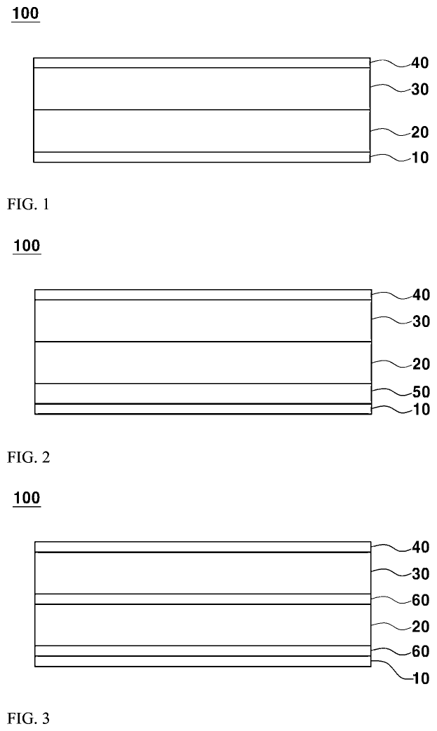

FIG. 1 shows a lithium secondary battery 100 according to an exemplary embodiment of the present disclosure. The lithium secondary battery 100 may include an anode current collector 10, a separator 20 disposed on the anode current collector 10, a cathode active material layer 30 disposed on the separator 20, and a cathode current collector 40 disposed on the cathode active material layer 30.

The lithium secondary battery 100 may include an electrolyte solution (not shown) with which at least one selected from among the anode current collector 10, the separator 20, the cathode active material layer 30, and the cathode current collector 40 is impregnated.

FIG. 2 shows the lithium secondary battery 100 that is charged. The lithium secondary battery 100 that is charged may further include a lithium metal element layer 50 between the anode current collector 10 and the separator 20. When the lithium secondary battery 100 is charged, lithium ions (Lit) deintercalated from the cathode active material of the cathode active material layer 30 pass through the separator via the electrolyte solution and move toward the anode current collector 10. The lithium ions (Lit) meet electrons on the anode current collector 10 and are precipitated and stored in the form of lithium metal element to form the lithium metal element layer 50.

In the present disclosure, an electrolyte solution having a specific composition, which does not react with lithium metal element that is precipitated and stored as described above and allows lithium ions (Lit) to be efficiently electrodeposited on the surface of the anode current collector 10, is used.

The electrolyte solution may include a solvent, a lithium salt, and an additive.

The solvent may include dimethylsulfamoyl fluoride represented by Chemical Formula 1 below. Since the solvent does not react with lithium metal element, side reaction between the electrolyte solution and the lithium metal element layer 50 may be effectively suppressed.

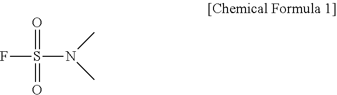

Meanwhile, when the lithium secondary battery 100 is repeatedly charged and discharged, a solid electrolyte interphase layer 60 may be formed between the cathode active material layer 30 and the separator 20 and/or between the anode current collector 10 and the separator 20 as shown in FIG. 3. When dimethylsulfamoyl fluoride is used as the solvent, the solid electrolyte interphase layer 60 is composed of an inorganic material rather than an organic material, so that side reaction between the electrolyte solution and lithium metal element may be effectively suppressed. If the solid electrolyte interphase layer 60 contains an organic material, electronic conductivity is increased, and thus, when lithium ions (Lit) are electrodeposited on the anode current collector 10, side reaction between the electrolyte solution and lithium metal element cannot be suppressed. Therefore, since a specific solvent is used in the present disclosure, the solid electrolyte interphase layer 60 is formed of an inorganic material having low electronic conductivity to thus prevent side reaction between the electrolyte solution and lithium metal element.

The solid electrolyte interphase layer 60 may include at least one selected from the group consisting of LiF, Li₂CO₃, LiO, and combinations thereof.

The lithium salt may include at least one selected from the group consisting of lithium bis(fluorosulfonyl)imide ((SO₂F)₂NLi, LiFSI), lithium bis(trifluoromethanesulfonyl)imide ((CF₃SO₂)₂NLi, LiTFSI), LiCI, LiBr, LiI, LiCIO₄, LiBF₄, LiB₁₀Cl₁₀, LiPF₆, LiCF₃SO₃, LiCF₃CO₂, LiCABO₈, LiAsF₆, LiSbF₆, LiAlCl₄, and combinations thereof.

The concentration of the lithium salt is not particularly limited, but the electrolyte solution may include about 0.5 M to 5 M, or about 0.5 M to 3 M of the lithium salt.

The additive may include a metal element. The metal element may have a work function higher than that of the anode current collector 10. Here, the work function of the anode current collector 10 may indicate the work function of an element constituting the anode current collector 10, particularly the substrate 11 included in the anode current collector 10.

The work function represents the energy difference required when one electron moves between the highest occupied energy level of electrons within a material (Fermi level) and the potential outside the material, and 1 eV is the work or energy required to move an electron through a potential difference of 1 V. The work function may be obtained through electronic structure calculation based on density functional theory.

Since the work function of the metal element is high, the metal element receives electrons from the element constituting the anode current collector 10, particularly the substrate 11, and thus an alloy of the metal element and the element constituting the substrate 11 may be formed on the surface of the anode current collector 10. The alloy allows lithium ions (Lit) to be efficiently electrodeposited on the anode current collector 10, thereby preventing overvoltage from occurring in the lithium secondary battery 100, ultimately suppressing side reaction between lithium metal element and the electrolyte solution.

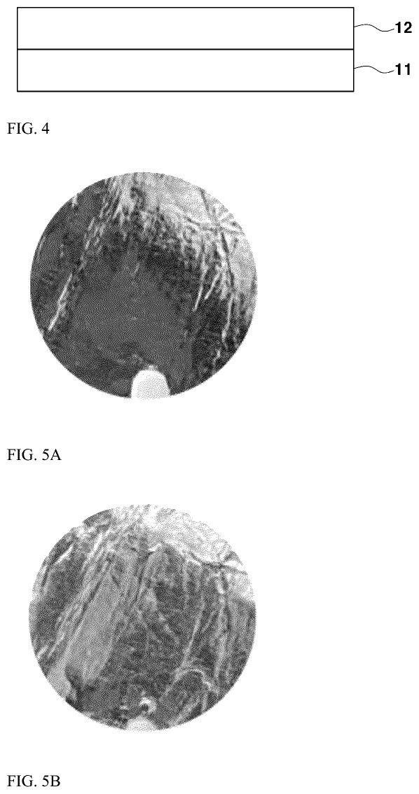

FIG. 4 shows the anode current collector 10. The anode current collector 10 includes a substrate 11 including copper (Cu) and a coating layer 12 applied onto the surface of the substrate 11 and including an alloy of copper (Cu) and the metal element.

Since the work function of copper (Cu) constituting the substrate 11 is about 4.7 eV, the work function of the metal element may be 6 eV or less but greater than 4.7 eV.

The metal element may include at least one selected from the group consisting of silver (Ag), gold (Au), platinum (Pt), and combinations thereof. The work function of silver (Ag) is about 4.73 eV, the work function of gold (Au) is about 5.1 eV, and the work function of platinum (Pt) is about 5.65 eV. When using an additive containing the same, the coating layer 12 may be formed.

The coating layer may include at least one selected from the group consisting of an alloy of copper (Cu) and silver (Ag), an alloy of copper (Cu) and gold (Au), an alloy of copper (Cu) and platinum (Pt), and combinations thereof.

The additive may include at least one selected from the group consisting of a nitrate of the metal element, a halogen salt of the metal element, and combinations thereof. Specifically, the additive may include at least one selected from the group consisting of AgNO₃, AuBr₃, Pt(NO₃)₄, and combinations thereof.

The electrolyte solution may include 0.05 wt % to 0.1 wt % of the additive. If the amount of the additive is less than 0.05 wt %, it may be difficult to form the coating layer 12.

The separator 20 may serve to separate the anode current collector 10 and the cathode active material layer 30 from each other and may provide a passage for lithium ions to move. In general, any material used as a separator in a lithium secondary battery may be used without particular limitation, and in particular, a material having low resistance to ion movement of the electrolyte solution, high ability to be impregnated with an electrolyte solution, and high safety may be included.

The separator 20 may include a porous polymer film, for example, a porous polymer film made of a polyolefin-based polymer such as ethylene homopolymer, propylene homopolymer, ethylene/butene copolymer, ethylene/hexene copolymer, and ethylene/methacrylate copolymer, or a laminated structure of two or more layers thereof.

Also, the separator 20 may include a porous non-woven fabric, for example, a non-woven fabric made of high-melting-point glass fiber, polyethylene terephthalate fiber, etc.

Also, the separator 20 may be coated with a ceramic component or a polymer material to attain heat resistance or mechanical strength.

The cathode active material layer 30 may include a cathode active material, a binder, a conductive material, etc.

The cathode active material may include at least one selected from the group consisting of lithium cobalt oxide, lithium nickel cobalt manganese oxide, lithium nickel cobalt aluminum oxide, lithium iron phosphate, lithium manganese oxide, and combinations thereof. However, the cathode active material is not limited thereto, and any cathode active material available in the art may be used.

The binder is a component that assists in bonding of the cathode active material and the conductive material and bonding to the current collector, and may include polyvinylidene fluoride, polyvinyl alcohol, carboxymethyl cellulose (CMC), starch, hydroxypropyl cellulose, recycled cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, and the like.

The conductive material is not particularly limited, so long as it has conductivity without causing chemical change in the battery, and examples thereof may include graphite such as natural graphite or artificial graphite, carbon-based materials such as carbon black, acetylene black, Ketjen black, channel black, furnace black, lamp black, summer black, etc., conductive fibers such as carbon fibers or metal element fibers, metal element powders such as carbon fluoride, aluminum, nickel powder, etc., conductive whiskers such as zinc oxide, potassium titanate, etc., conductive metal element oxides such as titanium oxide, etc., and conductive materials such as polyphenylene derivatives, etc.

The cathode current collector 40 may be a plate-like substrate having electrical conductivity. The cathode current collector 40 may include an aluminum foil.

A better understanding of the present disclosure may be obtained through the following examples. These examples are merely set forth to illustrate the present disclosure, and are not to be construed as limiting the scope of the present disclosure.

### Preparation Example 1

An electrolyte solution was prepared using components in the amounts shown in Table 1 below. Specifically, a solution was prepared by dissociating 3 M LiFSI in dimethylsulfamoyl fluoride (FSA) as a solvent. 1 wt % or more of calcium hydride (CaH₂) based on the total weight of the solution was placed in a container, the container was added to the solution, and the solution was dewatered by removing the container after about 30 minutes. The resulting solution was added with AgNO₃ as an additive to afford an electrolyte solution. The amount of the additive was adjusted to about 0.05 wt % based on the total weight of the electrolyte solution.

### Preparation Example 2

An electrolyte solution was prepared in the same manner as in Preparation Example 1, with the exception that the amount of AgNO₃ was increased to 0.1 wt %.

### Preparation Example 3

An electrolyte solution was prepared in the same manner as in Preparation Example 1, with the exception that AuBr₃ was used as an additive.

### Preparation Example 4

An electrolyte solution was prepared in the same manner as in Preparation Example 1, with the exception that Pt(NO₃)₄ was used as an additive.

### Comparative Preparation Example 1

An electrolyte solution was prepared in the same manner as in Preparation Example 1, with the exception that 1,2-dimethoxyethane (DME) was used as a solvent and an additive was not added.

### Comparative Preparation Example 2

An electrolyte solution was prepared in the same manner as in Preparation Example 1, with the exception that an additive was not added.

TABLE 1

| | | Solvent | | | | |
|---|---|---|---|---|---|---|
| | Salt | [vol %] | | Additive [wt %] | | |
| Classification | LiFSI | DME | FSA | AgNO₃ | AuBr₃ | Pt(NO₃)₄ |
| Preparation Example 1 | 3M | — | 100 | 0.05 | — | — |
| Preparation Example 2 | 3M | — | 100 | 0.1 | — | — |
| Preparation Example 3 | 3M | — | 100 | — | 0.05 | — |
| Preparation Example 4 | 3M | — | 100 | — | — | 0.05 |
| Comparative Preparation | 3M | 100 | — | — | — | — |
| Example 1 | | | | | | |
| Comparative Preparation | 3M | — | 100 | — | — | — |
| Example 2 | | | | | | |

### Test Example 1: Evaluation of Stability of Solvent to Lithium Metal Element

15 pi of lithium was stored in 2 g of a solvent for 1 week and changes with time were observed, followed by X-ray photoelectron spectroscopy (XPS) and FT-IR analysis.

Solvent 1: 1,2-dimethoxyethane (DME)
Solvent 2: Dimethylsulfamoyl fluoride (FSA)

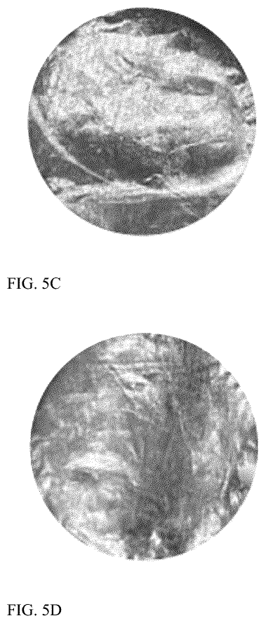

FIG. 5A, FIG. 5B, FIG. 5C, and FIG. 5D show changes with time when storing lithium in 1,2-dimethoxyethane for 1 week, FIG. 5A showing results on day 1, FIG. 5B showing results on day 3, FIG. 5C showing results on day 5, and FIG. 5D showing results on day 7.

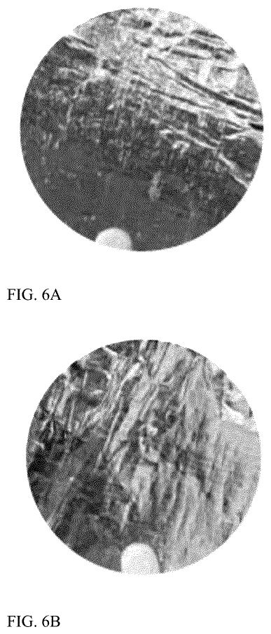

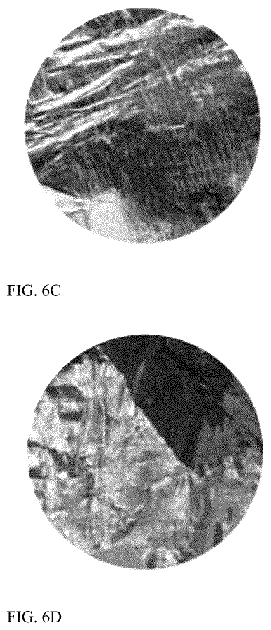

FIG. 6A, FIG. 6B, FIG. 6C, and FIG. 6D show changes with time when storing lithium in dimethylsulfamoyl fluoride for 1 week, FIG. 6A showing results on day 1, FIG. 6B showing results on day 3, FIG. 6C showing results on day 5, and FIG. 6D showing results on day 7.

With reference to FIG. 5A, FIG. 5B, FIG. 5C, and FIGS. 5D and 6A to 6D, when lithium metal element was stored in 1,2-dimethoxyethane or dimethylsulfamoyl fluoride, there was no change on the surface of lithium metal element.

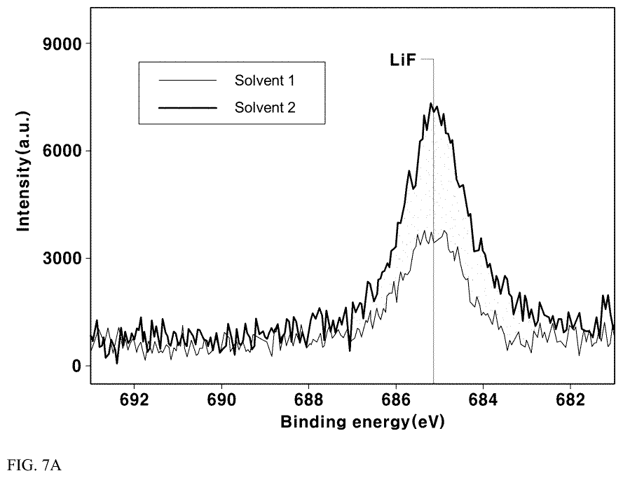

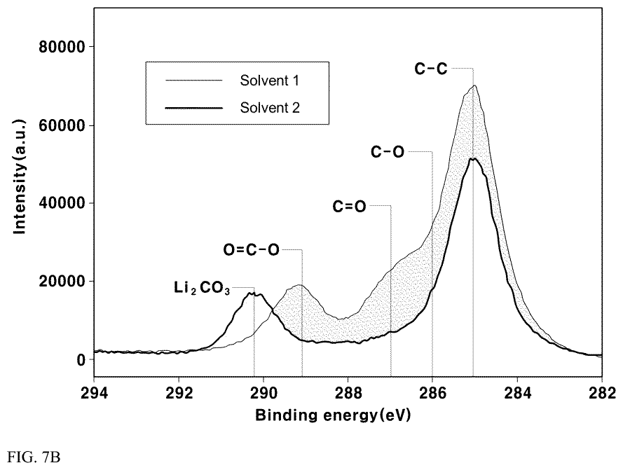

FIG. 7A, FIG. 7B, and FIG. 7C show results of analyzing the surface of lithium metal element by X-ray photoelectron spectroscopy (XPS) after storing lithium metal element in each solvent for 1 week, FIG. 7A showing results for the F Is peak, FIG. 7B showing results for the C Is peak, and FIG. 7C showing results for the O Is peak. Based on results of analysis, unlike 1,2-dimethoxyethane, which forms a solid electrolyte interphase layer made of an organic material, dimethylsulfamoyl fluoride was capable of forming a solid electrolyte interphase layer made of an inorganic material such as LiF, Li₂CO₃, or LiO.

Specifically, dimethylsulfamoyl fluoride was found to be a solvent with very high stability to lithium metal element due to formation of a solid electrolyte interphase layer made of an inorganic material and no byproducts dissolved in the electrolyte solution, compared to 1,2-dimethoxyethane.

### Test Example 2: Evaluation of Alloy Formation

A cell was manufactured as below, and the electrolyte solution of each of Preparation Examples 1 to 4 and Comparative Preparation Example 2 was injected into the cell.

Cell type: Cu/W-scope separator (16pi)/NCM811 cathode, 1.5T spacer, coin type cell (2032)

Amount of injected electrolyte solution: 15 μl

The cell into which the electrolyte solution was injected was aged at room temperature for about 5 hours, after which X-ray diffraction (XRD) and X-ray photoelectron spectroscopy (XPS) were performed on the surface of the anode current collector.

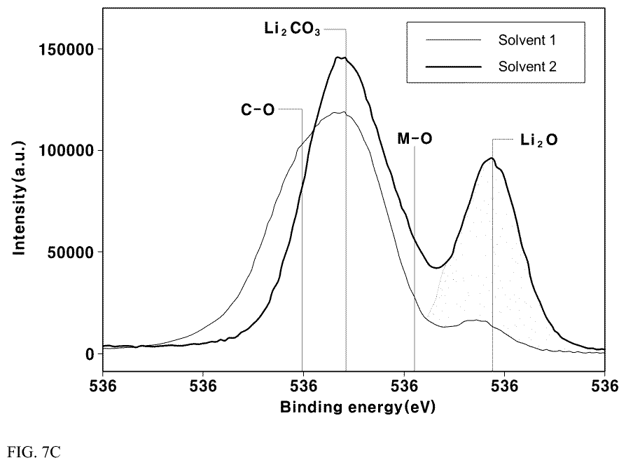

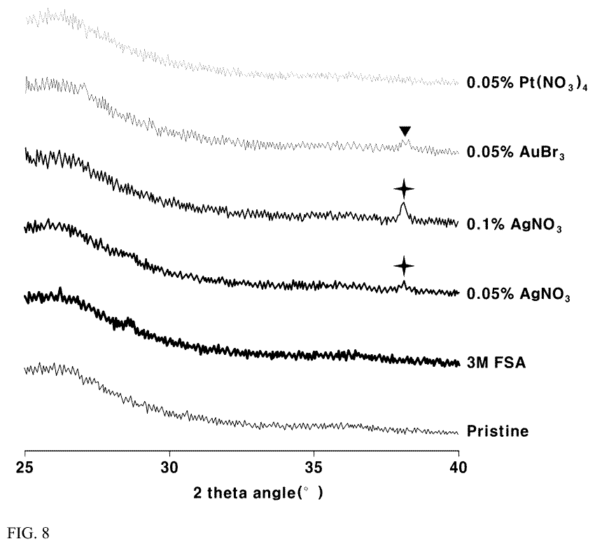

FIG. 8 shows results of X-ray diffraction (XRD) of the anode current collector of each cell. Unlike Comparative Preparation Example 2 (FSA) without an additive, 0.05% AgNO₃ (Preparation Example 1) and 0.1% AgNO₃ (Preparation Example 2) showed Ag (111) peaks, and 0.05% AuBr₃ (Preparation Example 3) showed Au (111) peaks. Thereby, when AgNO₃ or AuBr₃ was introduced, Ag or Au, having higher work function than Cu, was found to form an alloy by receiving electrons from Cu during a 5-hour rest period.

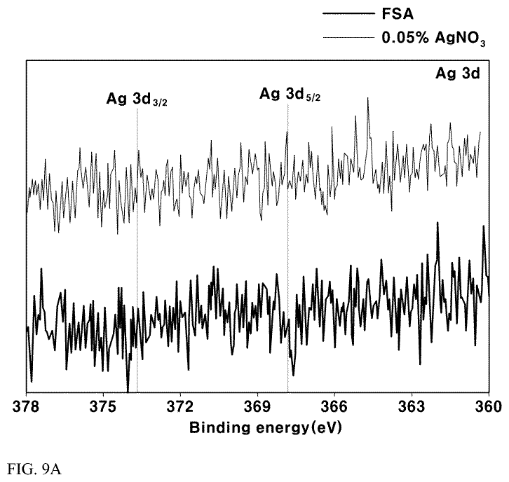

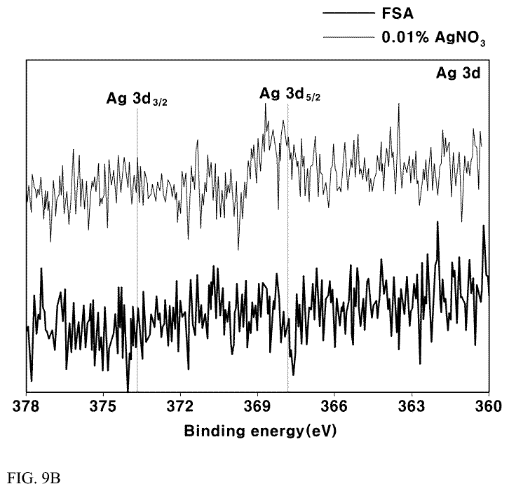

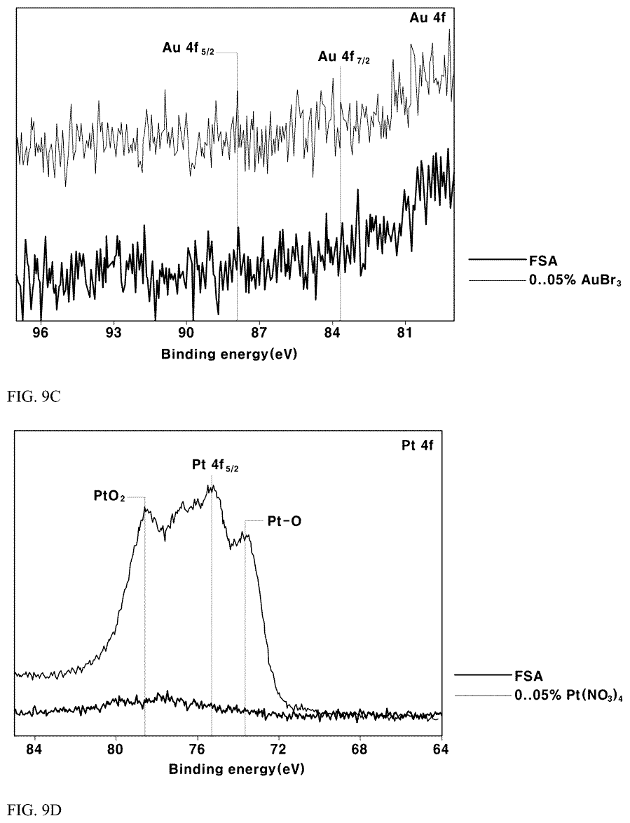

FIG. 9A, FIG. 9B, FIG. 9C, and FIG. 9D show results of X-ray photoelectron spectroscopy (XPS) of the anode current collector of each cell, FIG. 9A showing results for the Ag 3d peak, FIG. 9B showing results for the Ag 3d peak, FIG. 9C showing results for the Au 4f peak, and FIG. 9D showing results for the Pt 4f peak. Here, Ag peaks and Pt peaks appeared in 0.1% AgNO₃ (Preparation Example 2) and 0.05% Pt(NO₃) 4 (Preparation Example 4), respectively.

Thereby, it can be found that, when the electrolyte solution according to Preparation Examples 1 to 4 was injected, an alloy between the metal element of the additive and the component constituting the anode current collector was formed on the anode current collector.

### Test Example 3: Evaluation of Initial Efficiency of Cell

A cell was manufactured as below, and the electrolyte solution of each of Preparation Examples 1 to 4 and Comparative Preparation Example 2 was injected into the cell.

Cell type: 20 μm Li/W-scope separator (19pi)/Cu, 1.0T spacer, coin type cell (2032)

Amount of injected electrolyte solution: 15 μl

Test conditions: Aging at room temperature for 1 hour, formation charge/discharge current density (0.2 mAcm⁻²)

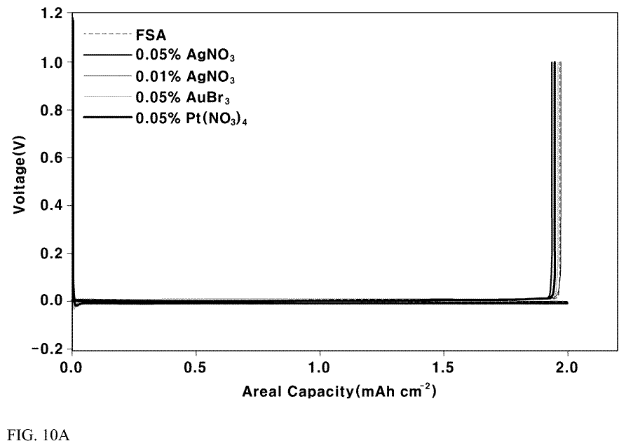

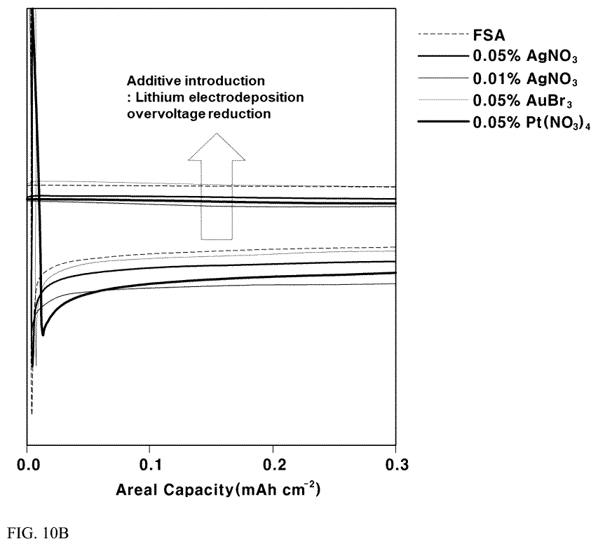

FIG. 10A shows an initial efficiency of each cell. FIG. 10B shows an enlarged view of FIG. 10A. When AgNO₃, AuBr₃, or Pt(NO₃)₄ was introduced, it was able to form an alloy with copper (Cu), resulting in low initial reversible efficiency compared to 3 M FSA without an additive. However, when comparing electrodeposition overvoltage, when AgNO₃, AuBr₃, or Pt(NO₃)₄ was introduced, electrodeposition overvoltage was greatly decreased. 3 M FSA without an additive showed an electrodeposition overvoltage of 34.6 mV, but 0.05% AgNO₃ showed an electrodeposition overvoltage of 26.1 mV, 0.1% AgNO₃ showed an electrodeposition overvoltage of 19.4 mV, 0.05% AuBr₃ showed an electrodeposition overvoltage of 25.7 mV, and 0.05% Pt(NO₃)₄ showed an electrodeposition overvoltage of 19.9 mV, indicating greatly decreased electrodeposition overvoltage. The above results are summarized in Table 2 below.

TABLE 2

| | Compar- | | | | |
|---|---|---|---|---|---|
| | ative | | | | |
| | Prepa- | Prepa- | Prepa- | Prepa- | Prepa- |
| | ration | ration | ration | ration | ration |
| Items | Example 2 | Example 1 | Example 2 | Example 3 | Example 4 |
| ICE [%] | 98.7 | 96.8 | 97.5 | 98.0 | 97.4 |
| Electro- | 34.6 | 26.1 | 19.4 | 25.7 | 19.9 |
| deposition | | | | | |
| overvoltage | | | | | |
| [mV] | | | | | |

FIG. 11 shows results of visual observation of electrodeposited lithium of each cell. In FIG. 11, FSA shows observation of the surface of the anode current collector, and FSA-separator shows observation of the surface of the separator. In case of 3 M FSA, since electrodeposition of lithium on the anode current collector did not occur efficiently, electrodeposited lithium was attached to the separator. This is an inherent problem of the anode current collector made of copper, and electrodeposition of lithium ions does not occur efficiently, and thus electrodeposition may become difficult and also side reaction with the electrolyte solution may occur due to overvoltage during electrodeposition.

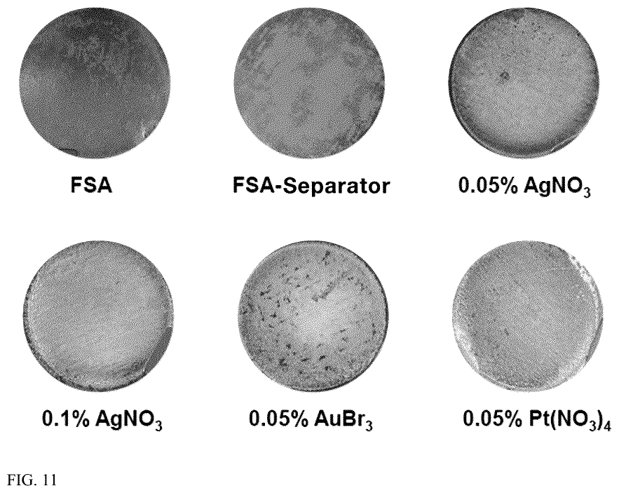

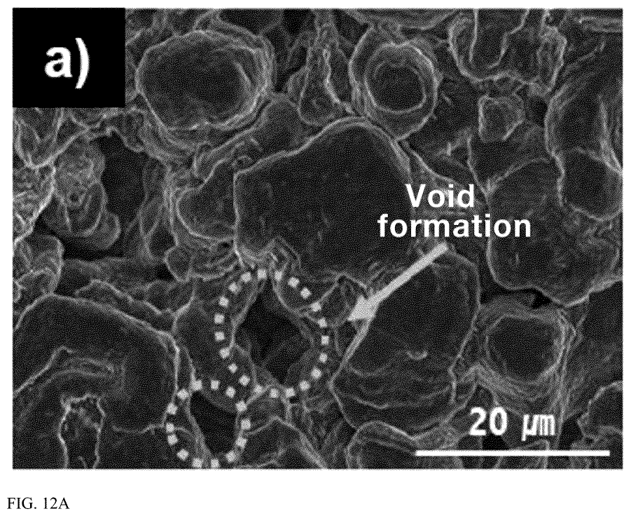

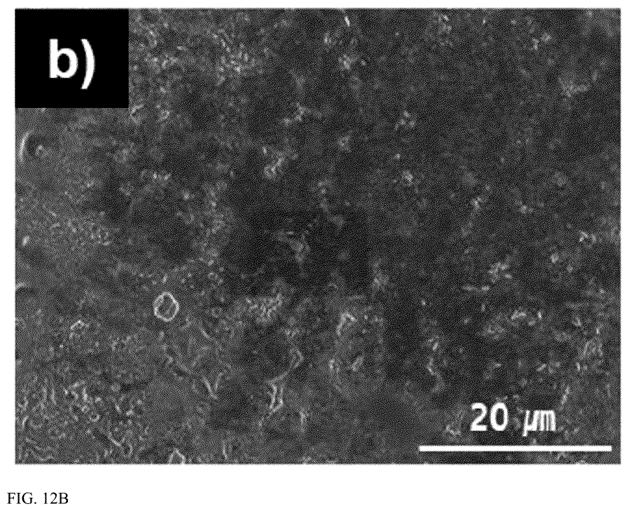

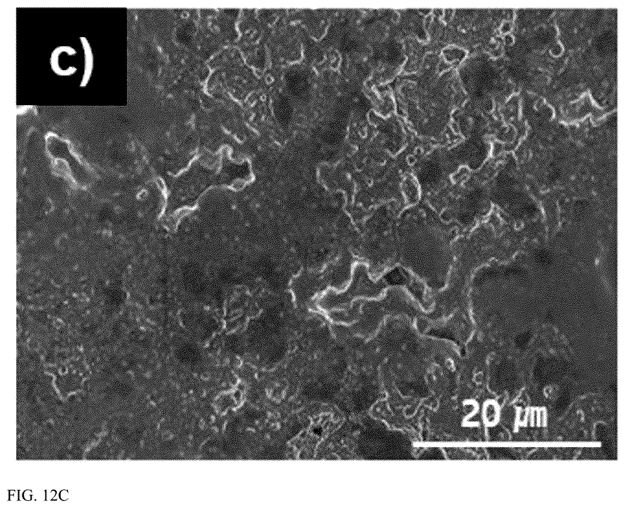

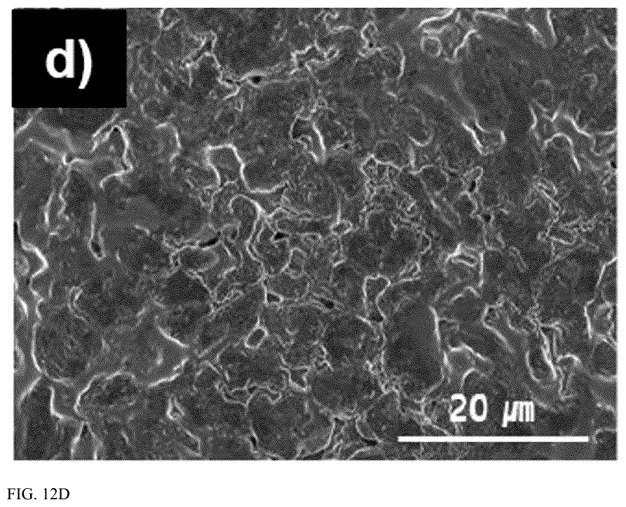

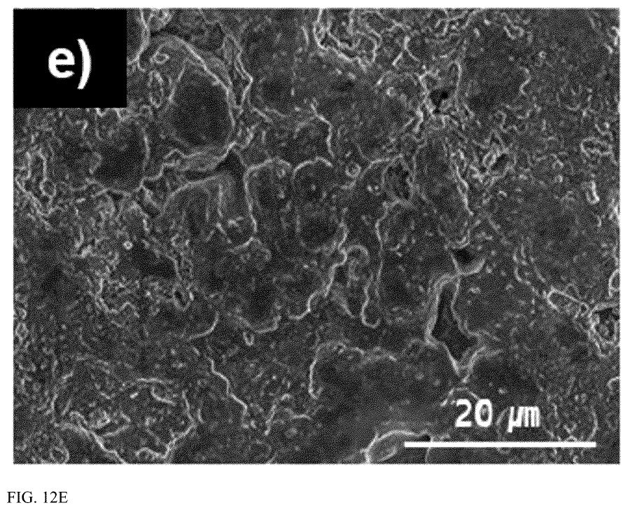

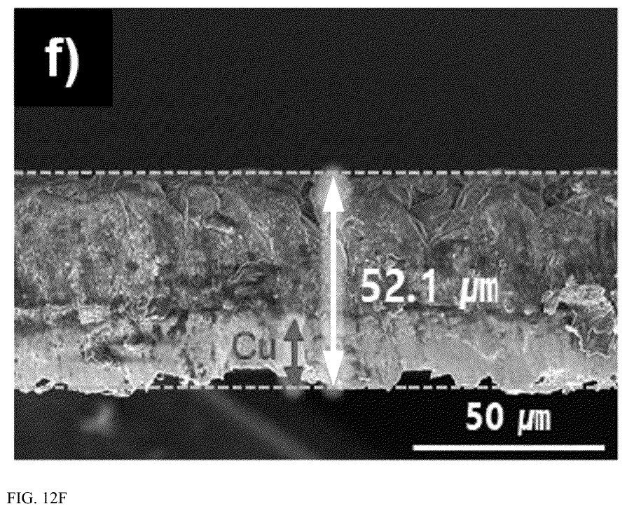

FIG. 12A to FIG. 12J shows results of analyzing the surface and cross section of electrodeposited lithium of each cell with a scanning electron microscope. FIG. 12A to 12E show surface results of electrodeposited lithium, and FIG. 12F to 12J show cross-section results of electrodeposited lithium. The items of FIG. 12A to 12J are summarized below.

A) 3 M FSA, B) 0.05% AgNO₃, C) 0.1% AgNO₃, D) 0.05% AuBr₃, E) 0.05% Pt(NO₃)₄

F) 3 M FSA, G) 0.05% AgNO₃, H) 0.1% AgNO₃, I) 0.05% AuBr₃, J) 0.05% Pt(NO₃)₄

The thickness of electrodeposited lithium is summarized in Table 3 below.

TABLE 3

| | Compar- | | | | |
|---|---|---|---|---|---|
| | ative | | | | |
| | Prepar- | Prepar- | Prepar- | Prepar- | Prepar- |
| | ation | ation | ation | ation | ation |
| Item | Example 2 | Example 1 | Example 2 | Example 3 | Example 4 |
| Thickness | 52.1 | 41.3 | 42.6 | 46.0 | 41.0 |
| [μm] | | | | | |

In case of 3 M FSA, voids were formed in the surface of electrodeposited lithium, and when voids exist in the surface of lithium, the electrolyte solution permeates into voids, causing side reaction between lithium and the electrolyte solution, which is undesirable. On the other hand, when AgNO₃, AuBr₃, or Pt(NO₃)₄ was introduced, it was confirmed that lithium was evenly electrodeposited without voids on the surface of electrodeposited lithium. The difference in morphology of electrodeposited lithium greatly affects the thickness of electrodeposited lithium. Specifically, it can be found that the electrolyte solution including the additive was capable of suppressing formation of voids, thus preventing side reaction between the electrolyte solution and lithium metal element, thereby making it possible to electrodeposit lithium at a low thickness.

### Test Example 4: Evaluation of Cell Lifespan

A cell was manufactured as below, and the electrolyte solution of each of Preparation Examples 1 to 4 and Comparative Preparation Example 2 was injected into the cell.

Cell type: 20 μm Li/W-scope separator (19pi)/Cu, 1.5T spacer, coin type cell (2032)

Amount of injected electrolyte solution: 15 μl

Test conditions: Aging at room temperature for 1 hour, formation charge/discharge current density (0.2 mAcm⁻²), cycle charge/discharge current density (0.6667 mAcm⁻²)

Coulombic efficiency (%): (cycle discharge capacity/cycle charge capacity)×100

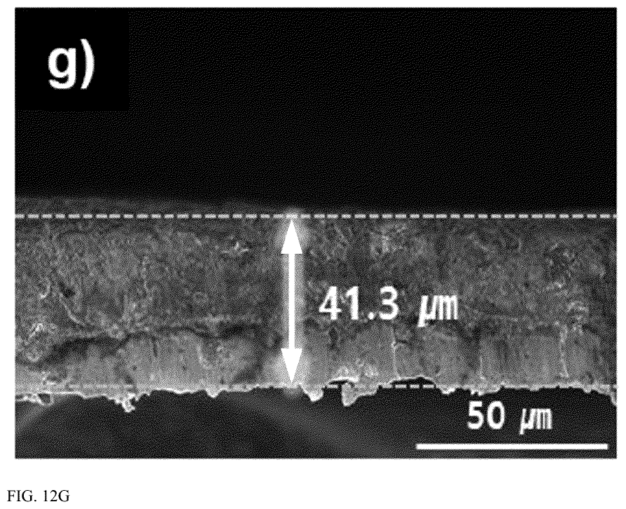

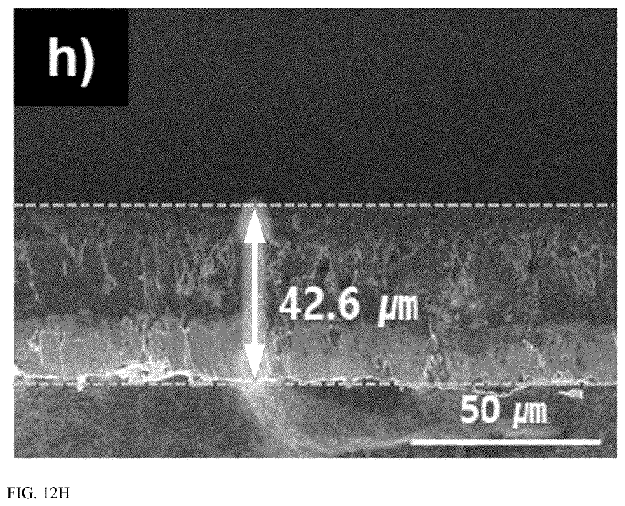

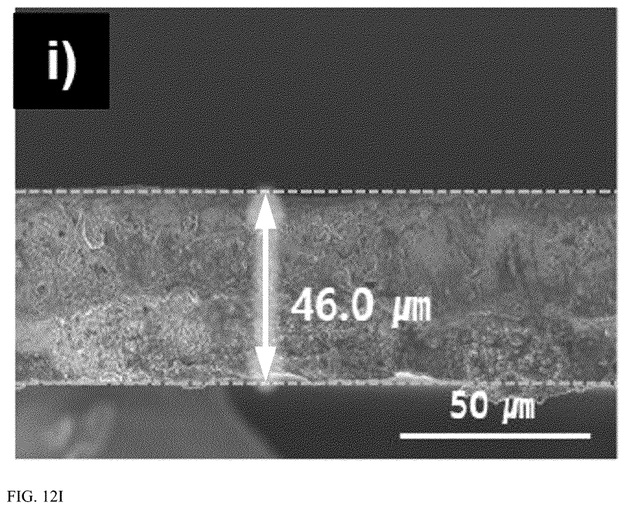

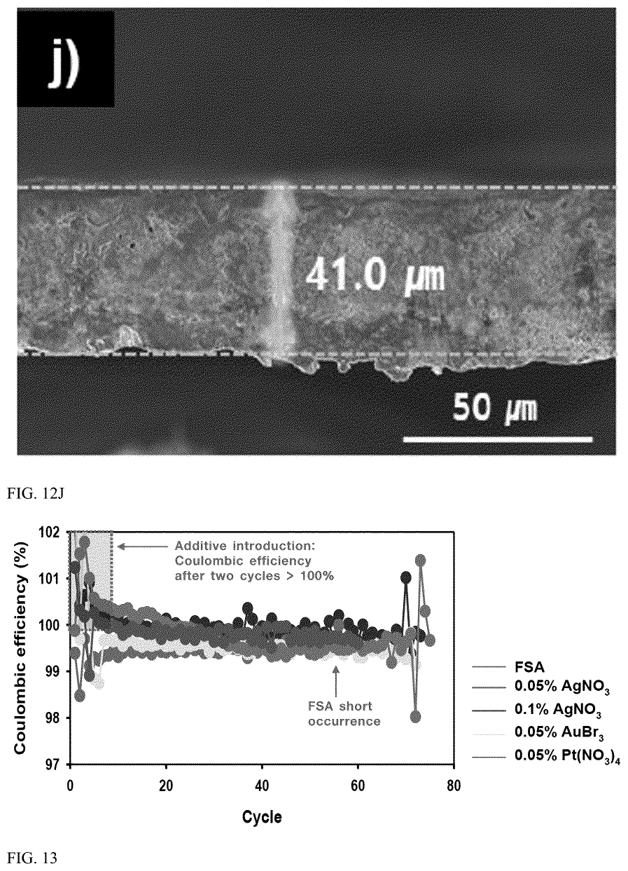

FIG. 13 shows results of evaluating the lifespan of each cell. 3 M FSA shorted out at the 57th cycle and coulombic efficiency thereof was less than 100% throughout cycling. However, 0.05% AgNO₃, 0.1% AgNO₃, 0.05% AuBr₃, and 0.05% Pt(NO₃)₄ exhibited 61 cycles, 74 cycles, 73 cycles, and 72 cycles, respectively, resulting in long lifespan, and initial cycle coulombic efficiency thereof was 100% or more.

When AgNO₃, AuBr₃, or Pt(NO₃)₄ was introduced, an alloy was formed on the anode current collector made of copper, so that coulombic efficiency was 100% or more in the initial cycle. Furthermore, since the alloy decreased overvoltage during lithium electrodeposition, the electrolyte solution introducing AgNO₃, AuBr₃, or Pt(NO₃) 4 exhibited long lifespan.

### Test Example 5: Evaluation of Anode-Free Cell Lifespan

A cell was manufactured as below, and the electrolyte solution of each of Preparation Examples 1 to 4 and Comparative Preparation Example 2 was injected into the cell.

Cell type: Cu/W-scope separator (16pi)/NCM811 cathode, 1.5T spacer, coin type cell (2032)

Amount of injected electrolyte solution: 15 μl

Test conditions: Aging at room temperature aging for 5 hours, formation charge/discharge twice (0.1C, 4.25V/−0.1C, 3.0V), cycle (1/3C, 4.25V/CV: 4.25V, 0.05C/−1/3C, 3.0V/rest 30 min), 1C=188.24 mAhg⁻¹

Coulombic efficiency (%): (cycle discharge capacity/cycle charge capacity)×100

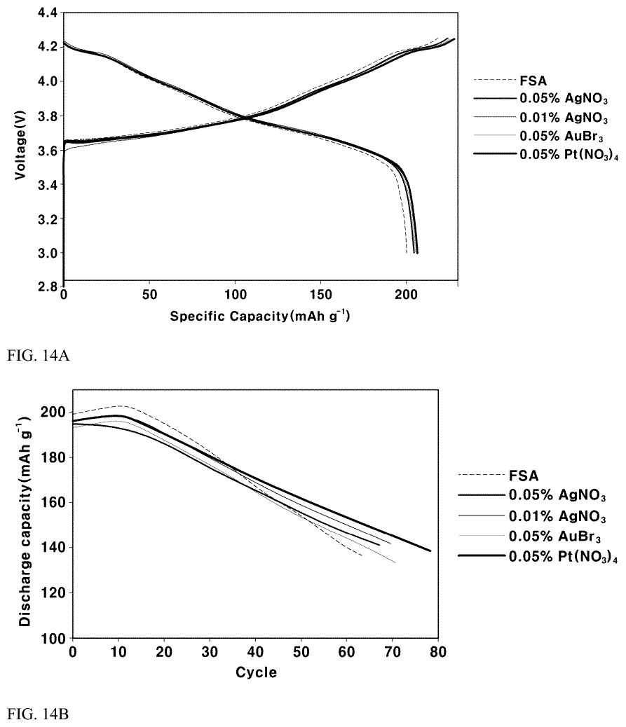

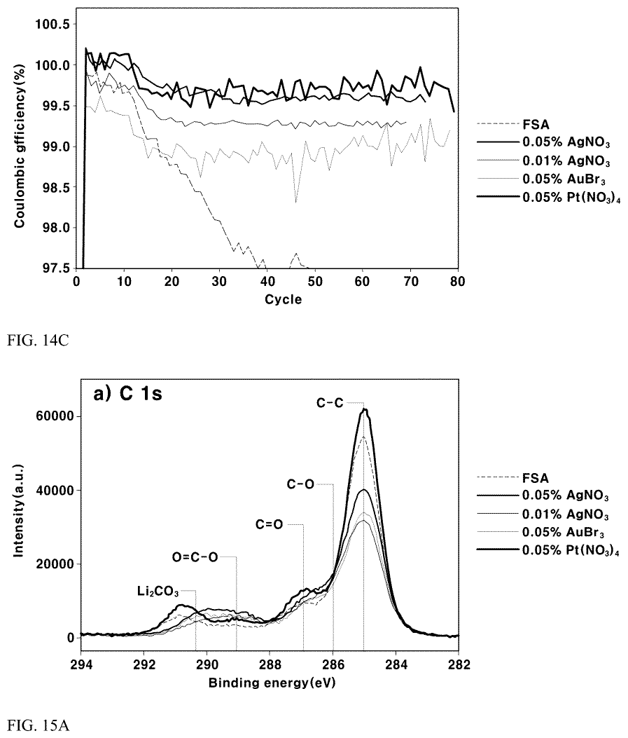

FIG. 14A shows a formation charge/discharge of each cell. FIG. 14B shows a cycle discharge capacity of each cell. FIG. 14C shows a coulombic efficiency of each cell. The results thereof are summarized in Table 4 below.

With reference to Table 4 and FIG. 14C, coulombic efficiency of 3 M FSA continuously decreased during cycling. In particular, a rapid decrease in coulombic efficiency occurred after the 11th cycle, which affects a decrease in discharge capacity and thus shortens lifespan. The electrolyte solution including AgNO₃, AuBr₃, or Pt(NO₃) 4 showed low initial reversible efficiency due to the formation of an alloy, but cycle coulombic efficiency remained constant and long lifespan compared to 3 M FSA resulted.

TABLE 4

| | Compar- | | | | |
|---|---|---|---|---|---|
| | ative | | | | |
| | Prepa- | Prepar- | Prepar- | Prepar- | Prepar- |
| | ration | ation | ation | ation | ation |
| | Exam- | Exam- | Exam- | Exam- | Exam- |
| Items | ple 2 | ple 1 | ple 2 | ple 3 | ple 4 |
| Charge | 218.5 | 224.0 | 225.8 | 225.5 | 227.8 |
| capacity [mAh/g] | | | | | |
| Discharge | 200.1 | 204.5 | 206.3 | 205.1 | 206.3 |
| capacity [mAh/g] | | | | | |
| ICE [%] | 91.6 | 91.3 | 91.4 | 91.0 | 90.6 |
| Room- | 60 | 72 | 72 | 69 | 79 |
| temperature | | | | | |
| lifespan | | | | | |
| (Retention | | | | | |
| 70%, cyc) | | | | | |
| Reversible | 98.0 | 99.6 | 99.6 | 98.9 | 99.7 |
| efficiency [%] | | | | | |

### Test Example 6: Evaluation of Electrode Interface of Anode-Free Cell

A cell was manufactured as below, and the electrolyte solution of each of Preparation Examples 1 to 4 and Comparative Preparation Example 2 was injected into the cell.

Cell type: Cu/W-scope separator (16pi)/NCM811 cathode, 1.5T spacer, coin type cell (2032)

Amount of injected electrolyte solution: 15 μl

Test conditions: Aging at room temperature for 5 hours, formation charge/discharge once (0.1C, 4.25V/−0.1C, 3.0V)

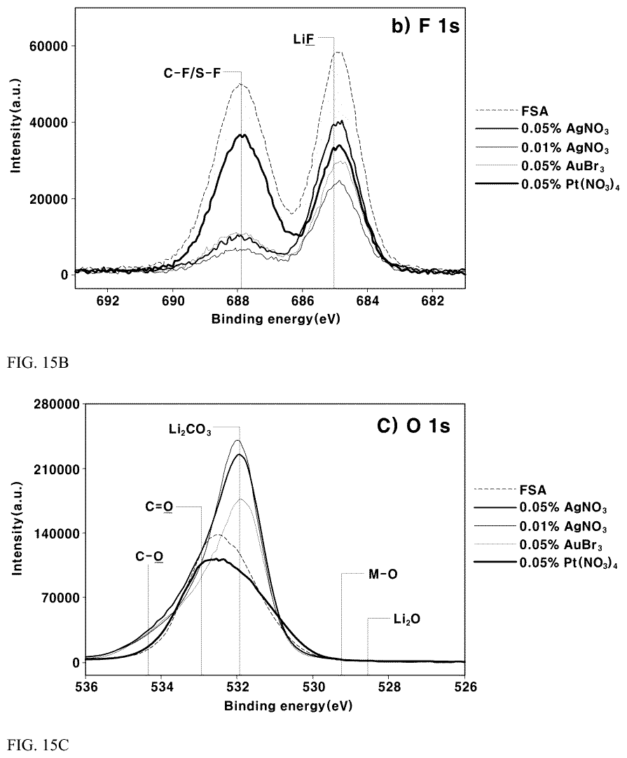

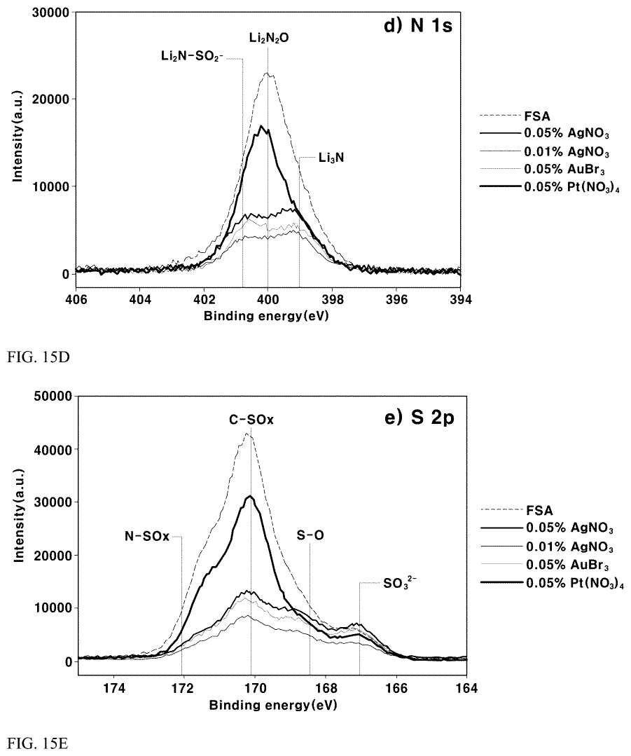

FIG. 15A to 15E shows results of X-ray photoelectron spectroscopy (XPS) of the surface of the anode current collector of each cell. With reference to FIG. 15A, 3 M FSA and 0.05% Pt(NO₃)₄ showed a high-intensity C—C peak compared to the electrolyte solution including AgNO₃ or AuBr₃. Since the C—C-based organic film has high electronic conductivity, there is a high concern of additional side reaction due to efficient movement of electrons. Also, it can be seen from FIG. 15B that 3 M FSA formed a solid electrolyte interphase layer based on high-intensity LiF and S-F. However, it can be seen through the high-intensity N and sulfur-based film that the film was formed due to side reaction of LiFSI lithium salt during lithium electrodeposition, rather than due to FSA decomposition.

On the other hand, referring to FIG. 15D to 15E, the electrolyte solution including AgNO₃, AuBr₃, or Pt(NO₃)₄ effectively suppressed LiFSI lithium salt decomposition, forming a low-intensity N and sulfur-based film. However, a LiF-based film was formed due to FSA decomposition during lithium electrodeposition. As such, a film made of an inorganic material such as LiF makes it difficult to move electrons due to low electronic conductivity, enabling effective suppression of side reaction between electrodeposited lithium and the electrolyte solution.

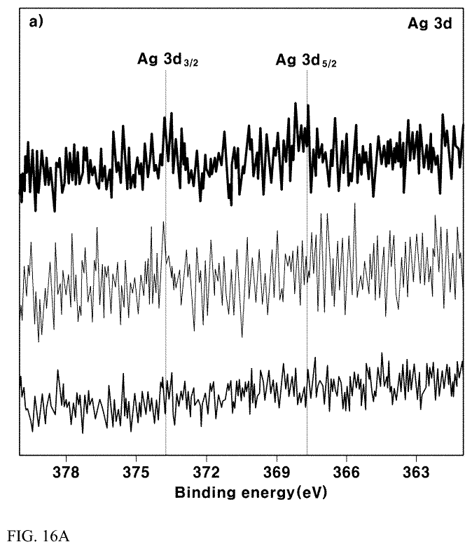

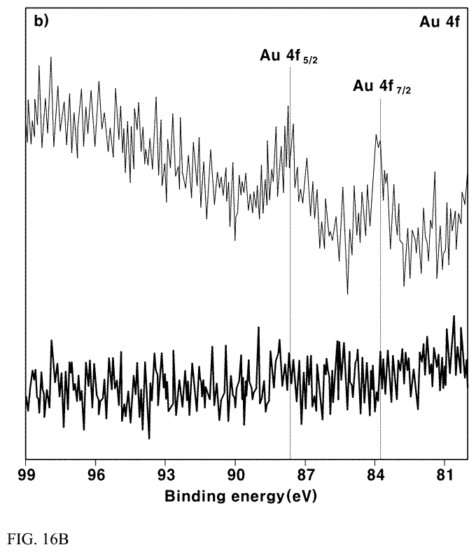

FIG. 16A to 16C shows results of X-ray photoelectron spectroscopy (XPS) of the surface of the anode current collector of each cell. With reference to FIG. 16A to 16C, Ag, Au, or Pt-based peaks appeared on the surface of the anode current collector. Thereby, the electrolyte solution including AgNO₃, AuBr₃, or Pt(NO₃)₄ was capable of forming an alloy on the surface of the anode current collector due to high work function during rest, thus decreasing lithium electrodeposition overvoltage, increasing the reversibility of lithium ions, and allowing the alloy to be maintained in a film form even after a formation process.

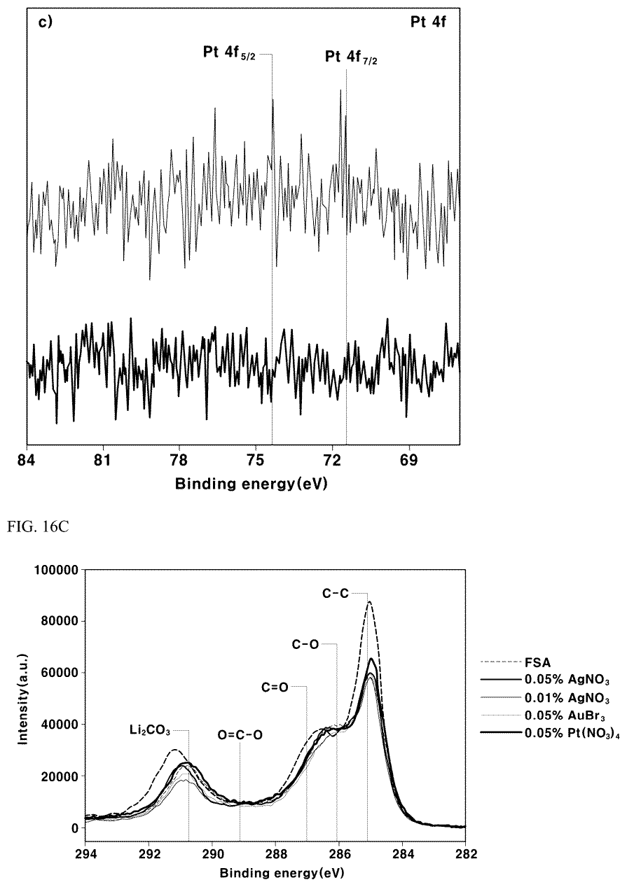

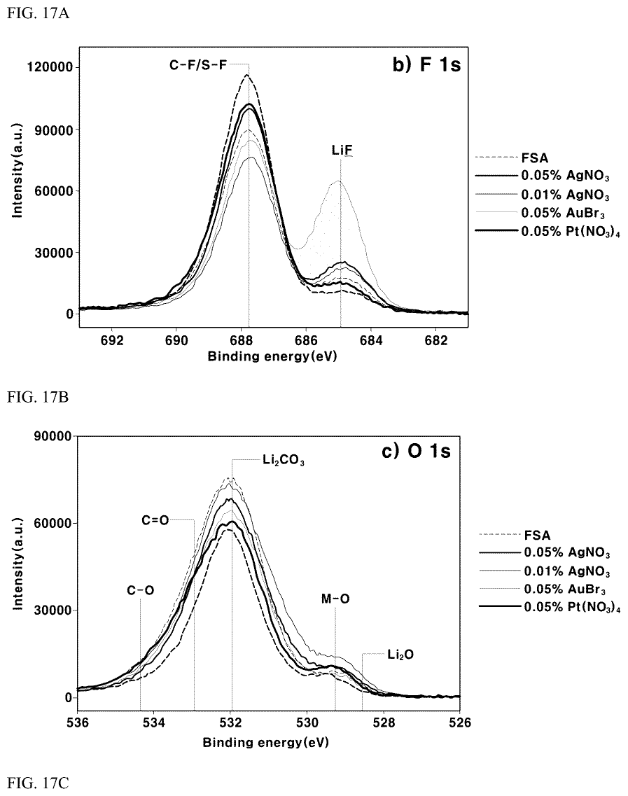

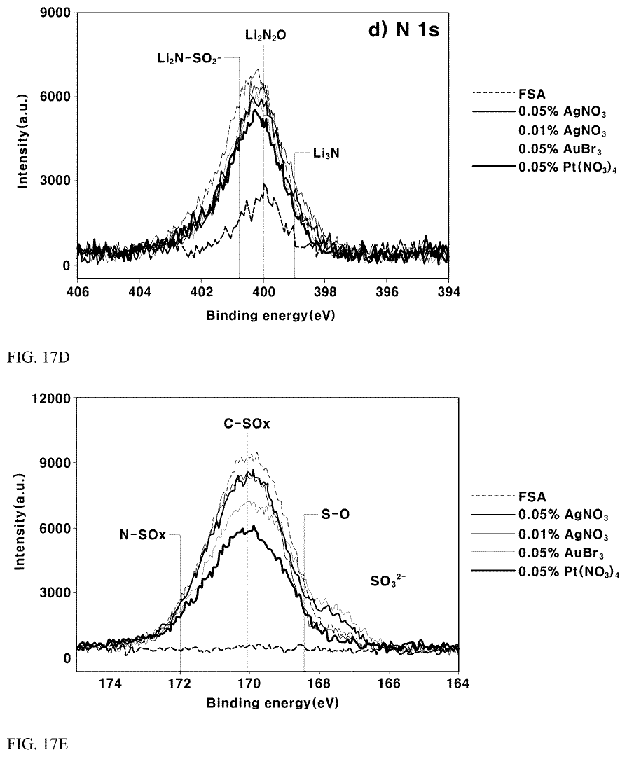

FIG. 17A to 17E shows results of X-ray photoelectron spectroscopy (XPS) of the surface of the cathode active material layer of each cell. Like FIG. 15A, 3 M FSA formed a high-intensity N and sulfur-based solid electrolyte interphase layer due to LiFSI lithium salt and FSA decomposition. With reference to FIG. 17C, since 3 M FSA did not inhibit side reaction between the lithium salt and the solvent, a thick byproduct solid electrolyte interphase layer was formed, resulting in a low-intensity M-O peak. A thick solid electrolyte interphase layer hinders the movement of lithium ions, causing overvoltage and deteriorating cell performance. On the other hand, as shown in FIGS. 17D and 17E, upon AgNO₃, AuBr₃, or Pt(NO₃)₄ introduction, it was possible to suppress LiFSI lithium salt and FSA decomposition even when used in a small amount, so that a low-intensity N and sulfur-based solid electrolyte interphase layer was formed, and a thin solid electrolyte interphase layer was formed through a high-intensity M-O peak.

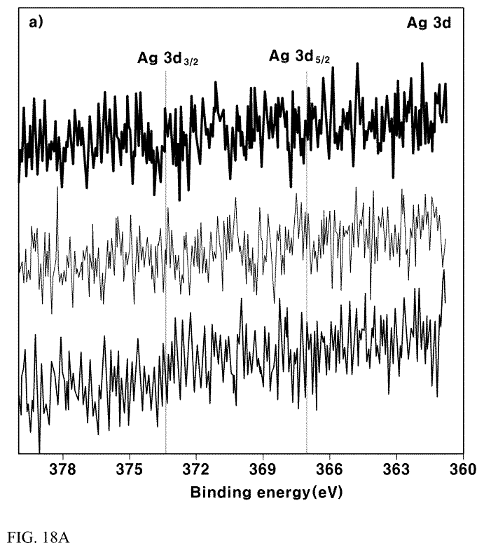

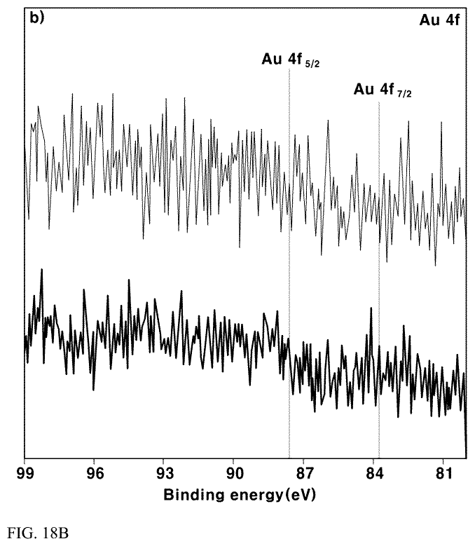

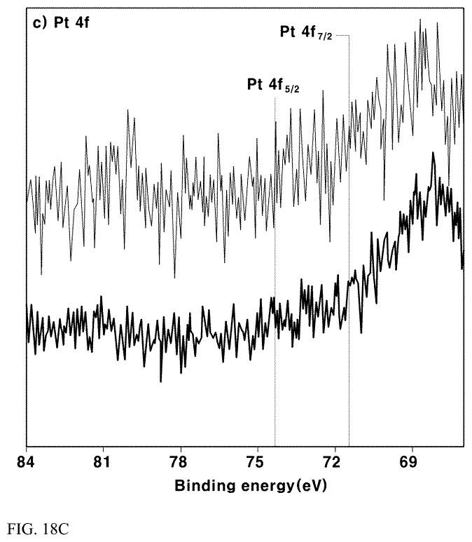

FIG. 18A to 18C shows results of X-ray photoelectron spectroscopy (XPS) of the surface of the cathode active material layer of each cell. With reference to FIG. 18A to 18C, Ag. Au, or Pt-based peaks did not appear on the surface of the cathode active material layer. Thereby, AgNO₃, AuBr₃, or Pt(NO₃)₄ was found to form an alloy on the anode current collector made of copper during rest and not to affect the cathode active material layer.

As is apparent from the above description, according to an exemplary embodiment of the present disclosure, a lithium secondary battery capable of suppressing side reaction between lithium metal element and an electrolyte solution can be obtained.

According to an exemplary embodiment of the present disclosure, a lithium secondary battery having excellent lithium ion reversibility can be obtained.

According to an exemplary embodiment of the present disclosure, a lithium secondary battery, in which specific capacity of a cathode is high, and even when the amount of injected electrolyte solution is small, good reversibility of lithium ions, no side reaction, and long lifespan are exhibited, can be obtained.

The effects of the present disclosure are not limited to the above-mentioned effects. It should be understood that the effects of the present disclosure include all effects that can be inferred from the description of the present disclosure.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrolyte solution for a lithium secondary battery, the electrolyte solution comprising:
a solvent;
a lithium salt; and
an additive comprising a metal element,
wherein the metal element comprises at least one selected from the group consisting of silver (Ag), gold (Au), platinum (Pt), and combinations thereof.

2. The electrolyte solution of claim 1, wherein the solvent comprises dimethylsulfamoyl fluoride.

3. The electrolyte solution of claim 1, wherein the lithium salt comprises at least one selected from the group consisting of lithium bis(fluorosulfonyl)imide ((SO₂F)₂NLi, LiFSI), lithium bis(trifluoromethanesulfonyl)imide ((CF₃SO₂)₂NLi, LiTFSI), LiCI, LiBr, LiI, LiCIO₄, LiBF₄, LiB₁₀Cl₁₀, LiPF₆, LiCF₃SO₃, LiCF₃CO₂, LiCABO₈, LiAsF₆, LiSbF₆, LiAlCl₄, and combinations thereof.

4. The electrolyte solution of claim 1, wherein the additive comprises at least one selected from the group consisting of a nitrate of the metal element, a halogen salt of the metal element, and combinations thereof.

5. The electrolyte solution of claim 1, wherein the additive comprises at least one selected from the group consisting of AgNO₃, AuBr₃, Pt(NO₃)₄, and combinations thereof.

6. The electrolyte solution of claim 1, wherein the electrolyte solution comprises 0.05 wt % to 0.1 wt % of the additive.

7. A lithium secondary battery, comprising:
an anode current collector;
a separator disposed on the anode current collector;
a cathode active material layer disposed on the separator;
a cathode current collector disposed on the cathode active material layer; and
an electrolyte solution impregnated in at least one of the cathode active material layer, and the cathode current collector,
wherein the electrolyte solution comprises a solvent, a lithium salt, and an additive comprising a metal element, and
wherein a work function of the metal element is higher than a work function of the anode current collector.

8. The lithium secondary battery of claim 7, wherein the anode current collector comprises:
a substrate comprising copper (Cu); and
a coating layer applied onto a surface of the substrate and comprising an alloy of copper (Cu) and the metal element.

9. The lithium secondary battery of claim 7, wherein the solvent comprises dimethylsulfamoyl fluoride.

10. The lithium secondary battery of claim 7, wherein the lithium salt comprises at least one selected from the group consisting of lithium bis(fluorosulfonyl)imide ((SO₂F)₂NLi, LiFSI), lithium bis(trifluoromethanesulfonyl)imide ((CF₃SO₂)₂NLi, LiTFSI), LiCI, LiBr, LiI, LiCIO₄, LiBF₄, LiB₁₀Cl₁₀, LiPF₆, LiCF₃SO₃, LiCF₃CO₂, LiCABO₈, LiAsF₆, LiSbF₆, LiAlCl₄, and combinations thereof.

11. The lithium secondary battery of claim 7, wherein a work function of the metal element is greater than 4.7 eV and smaller than or equal to 6 eV.

12. The lithium secondary battery of claim 7, wherein the metal element comprises at least one selected from the group consisting of silver (Ag), gold (Au), platinum (Pt), and combinations thereof.

13. The lithium secondary battery of claim 7, wherein the anode current collector comprises a coating layer comprising at least one selected from the group consisting of an alloy of copper (Cu) and silver (Ag), an alloy of copper (Cu) and gold (Au), an alloy of copper (Cu) and platinum (Pt), and combinations thereof on a surface thereof.

14. The lithium secondary battery of claim 7, wherein the additive comprises at least one selected from the group consisting of a nitrate of the metal element, a halogen salt of the metal element, and combinations thereof.

15. The lithium secondary battery of claim 7, wherein the additive comprises at least one selected from the group consisting of AgNO₃, AuBr₃, Pt(NO₃)₄, and combinations thereof.

16. The lithium secondary battery of claim 7, wherein the electrolyte solution comprises 0.05 wt % to 0.1 wt % of the additive.

17. The lithium secondary battery of claim 7, further comprising a solid electrolyte interphase layer in at least one position between the cathode active material layer and the separator and between the anode current collector and the separator, wherein the solid electrolyte interphase layer does not comprise an organic material.

18. The lithium secondary battery of claim 7, further comprising a solid electrolyte interphase layer in at least one position between the cathode active material layer and the separator and between the anode current collector and the separator, wherein the solid electrolyte interphase layer comprises at least one selected from the group consisting of LiF, LizCO₃, LiO, and combinations thereof.
